(19) United States
(12) Patent Application Publication
(10) Pub. No.: US 2011/0101056 A1
(43) Pub. Date: May 5, 2011

(54) ROOF RACK FOR JEEP-TYPE VEHICLE

(75) Inventor: Martin BARKEY, Huntsville (CA)

(73) Assignee: MBRP INC., Huntsville (CA)

(21) Appl. No.: 12/611,617

(22) Filed: Nov. 3, 2009

(51) Int. Cl. B60R 9/052; B60R 9/058

(52) U.S. Cl. 224/321; 224/325

(57) ABSTRACT

A roof rack for a jeep type vehicle having a removable canopy. The roof rack having a rack member suspended overtop of the canopy by mounting members which are connected to support brackets positioned inside the canopy. Portions of side surfaces of the canopy are positioned between the connection of the mounting members and the support brackets. The support brackets transfer loads from the rack member to the vehicle without requiring mounting to bumpers or a windshield frame of the jeep type vehicle.

### FIELD OF THE INVENTION

The present invention relates generally to a roof rack for a jeep type vehicle. More particularly, the present invention relates to a roof rack that is fixed over top of a canopy of the jeep type vehicle and is supported by brackets positioned inside the canopy to transfer loads from the roof rack to the frame of the jeep type vehicle.

### BACKGROUND OF THE INVENTION

Roof racks that are fixed to a roof of an automobile have been known for some time. Conventional roof racks are used to carry bulky items such as bicycles, canoes, kayaks, skis, as well as bulk carriers and containers. Generally, these roof racks are mounted to the roof of an automobile, for example, mounted to the gutter surrounding the roof line, or by suction cups fixed to the roof. As such, loading to the roof rack is transferred to the vehicle frame though the roof.

However, conventional attachment can not be made to jeep vehicles with a removable canopy. Typically, such removable canopies are made of material such as fiberglass. Fiberglass can not sustain as high loading as can be applied to metal roofs of automobiles. As such, roof racks for jeep type vehicles have been attached to the windshield frame at a front of the jeep, and the bumper at the back of the vehicle. However, this attachment of the roof rack obstructs removal of the canopy. Also, jeep owners frequently change their bumpers and therefore new or different mounting hardware is required to attach to the bumper.

Accordingly, it is desirable to have a roof rack that is attachable or positionable on the canopy and can sufficiently support loading on the roof rack without requiring attachment to the windshield frame and/or bumpers.

### SUMMARY OF THE INVENTION

It is an object of the present invention to obviate or mitigate at least one disadvantage of previous roof rack constructions.

The inventor of the roof rack has surprisingly found that the present invention enables easier attachment of a roof rack to a jeep type vehicle with a removable canopy so as to permit the canopy to be removed without difficulty. The inventor has also surprisingly found that the present invention provides a roof rack that can withstand substantial loading and does not require mounting to bumpers of the vehicle.

In one aspect, the present invention resides in a roof rack for attachment to a vehicle having a removable canopy, the removable canopy having a top panel with a first edge and a second edge, a first side panel having an inner side and an outer side, the first side panel extending downward from the first edge, and a second side panel having an inner side and an outer side, the second side panel extending downward from the second edge; the roof rack comprising a rack member with a first mounting arm and a second mounting arm, a first support bracket, and a second support bracket, the first mounting arm disposed at the outer surface of the first side panel and attached to the first support bracket positioned at the inner surface of the first side panel with a portion of the first side panel disposed therebetween; the second mounting arm disposed at the outer surface of the second side panel and attached to the second support bracket positioned at the inner surface of the second side panel with a portion of the second side panel disposed therebetween; such that the rack member is supported above the top panel.

In another aspect, the present invention resides in a roof rack for attachment to a vehicle having a removable canopy, the removable canopy having a top panel extending in a generally horizontal plane, the top panel having a first horizontal edge and a second horizontal edge, a first side panel extending downward from the first horizontal edge, the first side panel having an inner surface and an outer surface, and a second side panel extending downward from the second horizontal edge, the second side panel extending downward from the second edge, wherein the roof rack comprises a rack member having a first support member, a second support member, a third support member, a fourth support member, and a first mounting bracket, second mounting bracket, a third mounting bracket and a fourth mounting bracket, the first support member disposed at the outer surface of the first side panel and having a first attachment bracket connecting to the first mounting bracket disposed at the inside of the removable canopy with a portion of the first side panel disposed therebetween; the second support member disposed at the outer surface of the second side panel and having a second attachment bracket connecting to the second mounting bracket positioned at the inner surface of the second side panel with a portion of the second side panel disposed therebetween; the third support member disposed at the outer surface of the first side panel and having a third attachment bracket connecting to the third mounting bracket disposed at the inside of the removable canopy with a portion of the first side panel disposed therebetween; and the fourth support member disposed at the outer surface of the second side panel and having a fourth attachment bracket connecting to the second mounting bracket positioned at the inner surface of the second side panel with a portion of the second side panel disposed therebetween; wherein the rack member is supported at a horizontal distance above the top panel.

### BRIEF DESCRIPTION OF THE DRAWINGS

Other objects and advantages of the invention will become apparent upon reading the detailed description and upon referring to the drawings in which:

FIG. 1 shows a roof rack attached to a jeep-type vehicle with a removable canopy in accordance with one embodiment of the present invention;

FIG. 2 shows a rear view of the jeep-type vehicle shown in FIG. 1 with the removable canopy cut-away along line X-X;

FIG. 3 shows the roof rack of FIG. 1 in exploded view;

FIG. 4 shows a roof rack attached to a jeep-type vehicle with a removable canopy in accordance with another embodiment of the present invention;

FIG. 5 shows the roof rack of FIG. 4 in exploded view;

FIG. 6 shows the roof rack of FIG. 4 in side view; and

FIG. 7 shows the first support arm of the roof rack in FIG. 4.

### DETAILED DESCRIPTION OF PREFERRED EMBODIMENTS

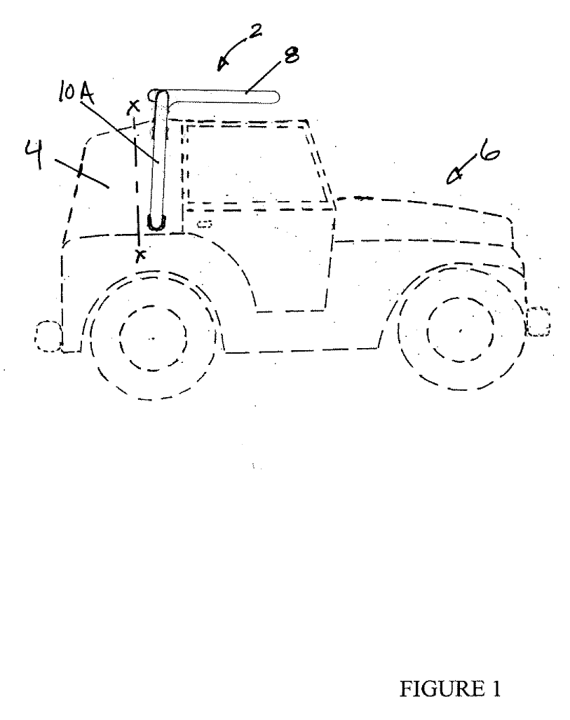

FIG. 1 shows a roof rack 2 connected to a removable canopy 4 of a jeep type vehicle 6. The roof rack 2 has a top rack assembly 8 and a first mounting arm 10A. The second mounting arm 10B is not shown in FIG. 1. The mounting arm 10A extends downward from the top rack assembly 8.

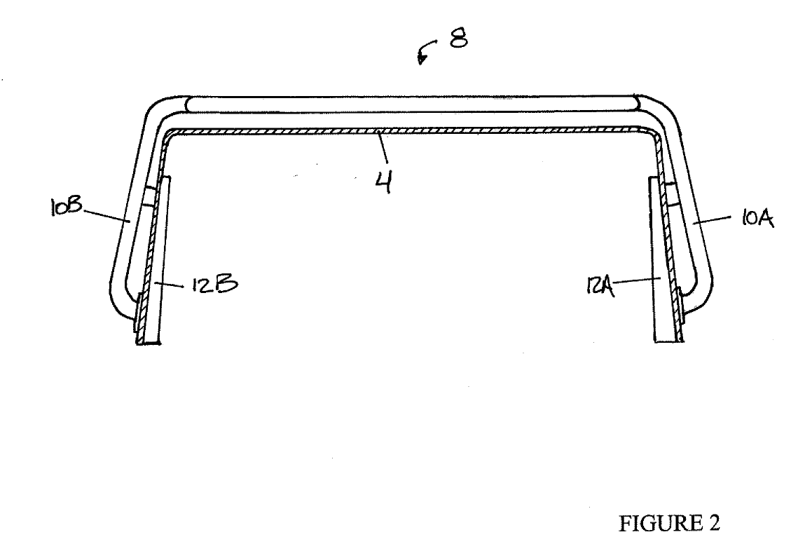

FIG. 2 shows a rear view of the jeep-type vehicle 6 of FIG. 1 with the removable canopy 4 cut-away along line X-X. As shown, the first mounting arm 10A is attached to a first support bracket 12A with a portion of the removable canopy 4 position there between. A similar attachment of the second mounting arm 10B to a second support bracket 12B is shown with a portion of the removable canopy 4 therebetween.

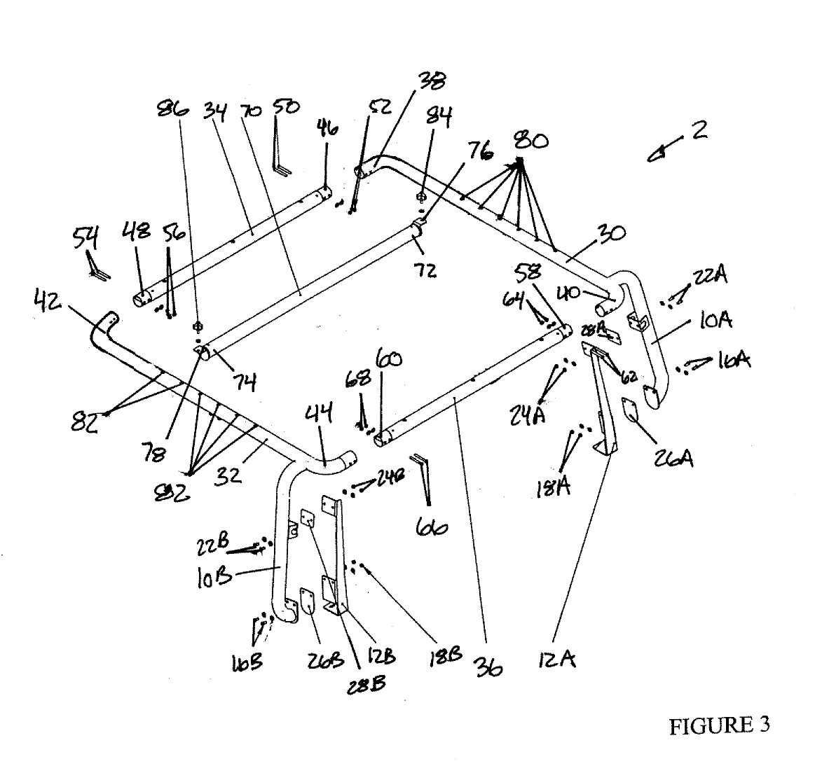

The connection of the first mounting arm 10A to the first support bracket 12B and the second mounting arm 10B to the second support bracket 12B is made at two locations shown in FIG. 2. As can be visualized more clearly in FIG. 3, a mounting plate 14A is provided proximate to a bottom end of the first mounting arm 10A. The first mounting plate 14A is connected to the first support bracket 12A by positioning threaded bolts 16A through holes in the first mounting plate 14A in respective holes in the first support bracket 12A and then secured by nuts 18A. Also, washers are provided as shown.

A mounting bracket 20A is fixed at a position vertically upwards from the mounting plate 14A on the first mounting arm 10A. The mounting bracket 20A is also attached to the first support bracket 12A using bolts 22A which are fitted through respective holes in the mounting bracket 20A and support bracket 12A and secured by nuts 24A.

As shown in FIG. 3, a mounting plate gasket or sealing member 26A is provided between the mounting plate 14A and support bracket 12A. The purpose of the mounting plate gasket or sealing member is to prevent the infiltration of water between the mounting of the mounting plate 14A and the canopy (not shown). A similar mounting bracket gasket or sealing member 28A is provided between the mounting bracket 20A and support bracket 12A. The mounting bracket gasket or sealing member is also to prevent the infiltration of water between the mounting bracket 20A and the canopy.

A similar mounting of the second mounting arm 108 to the second support bracket 12B is made as shown in FIG. 3. The connection of the second mounting arm 10B to the second support bracket 12B is made at two locations shown in FIG. 3. A mounting plate 14B is provided proximate to a bottom end of the second mounting arm 10B. The first mounting plate 14B is connected to the second support bracket 12B by positioning threaded bolts 16B through holes in the second mounting plate 14B in respective holes in the second support bracket 12B and then secured by nuts 18B. Also, washers are provided as shown.

A mounting bracket 206 is fixed at a position vertically upwards from the mounting plate 14B on the second mounting arm 10B. The mounting bracket 20B is also attached to the support bracket 12B using bolts 22B which are fitted through respective holes in the mounting bracket 20B and support bracket 12B and secured by nuts 24B.

As shown in FIG. 3, a mounting plate gasket or sealing member 26B is provided between the mounting plate 14B and second support bracket 12B. The purpose of the mounting plate gasket or sealing member is to prevent the infiltration of water between the mounting of the mounting plate 14B and the canopy (not shown). A similar mounting bracket gasket or sealing member 28B is provided between the mounting bracket 20B and support bracket 12B. The mounting bracket gasket or sealing member is also to prevent the infiltration of water between the mounting bracket 20B and the canopy.

FIG. 3 also shows the rack member comprising a first side member 30, a second side member 32, a front member 34, and a rear member 36. The first side member 30 has a front end 38 and a rear end 40. Similarly, the second side member has a front end 42 and a rear end 44.

The front member 34 has a first end 46 and a second end 48. The first end 46 and second end 48 have a reduced diameter such that they can be fitted into respective front ends 38 and 42 of the first side member 30 and second side member 32, respectively. The front member 34 is connected to lead the first side member 30 by inserting the first end 46 of the front member into the front end 38 and then securing the connection using bolts 50 inserted through apertures in each of the first end and front end and then securing the bolts 50 with nuts 52. A similar connection is made to fix the second end 48 of the front member 34 to the front end 42 and the second side member 32. The second end 48 is inserted into the front end 42 and secured thereto using bolts 54 inserted through respective holes in the second end 48 and front end 42 and are then secured using nuts 56.

The rear member 36 as a reduced diameter first end 58 and a reduced diameter second end 60. The rear member 36 is connected to the respective first side member 30 and second side member 32 and as follows. The reduced diameter first end 58 is inserted into the rear end of the first side member 40 and secured thereto using bolts 62 inserted through respective holes in the first end 58 and rear end 40 and are secured by nuts 64. The second end 60 is inserted into the rear end 44 of the second side member 32 and secured thereto using bolts 66 inserted through respective holes in the second end 60 and rear end 44 and secured using nuts 68.

Also shown in FIG. 3 is a removable horizontal member 70 which can be positioned in various horizontal locations of the rack member. The removable member is adjustably secured to the respective first side member 30 and second side member 32 as follows. The removable member 70 has a first end 72 and a second end 74. The first end 72 has a first bracket 76 with an aperture, and the second end 74 has a second bracket 78 with an aperture. The first side member 30 has threaded apertures. Plurality of threaded apertures 80, and the second side member 32 has a plurality of threaded apertures 82. The first bracket 76 is attached to the first side member 30 by positioning the aperture in the first bracket over top of a user selected threaded aperture 80 and then threadably securing a threaded knob 84 into the user selected threaded aperture 80. Similarly, the second bracket 78 is secured to the second side member 32 by positioning the aperture in the second end 74 over top of a user selected threaded aperture 82 and threadably securing a threaded knob 86 thereto.

The removable member 70 can be positioned at user selected horizontal locations on each of the first side member and second side member by selecting a desired threaded aperture on respective first side member 30 and second side member 32.

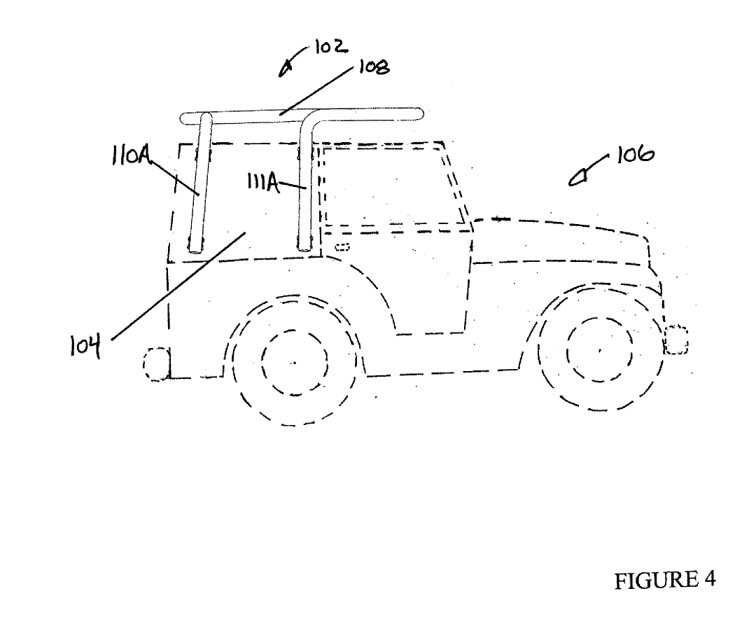

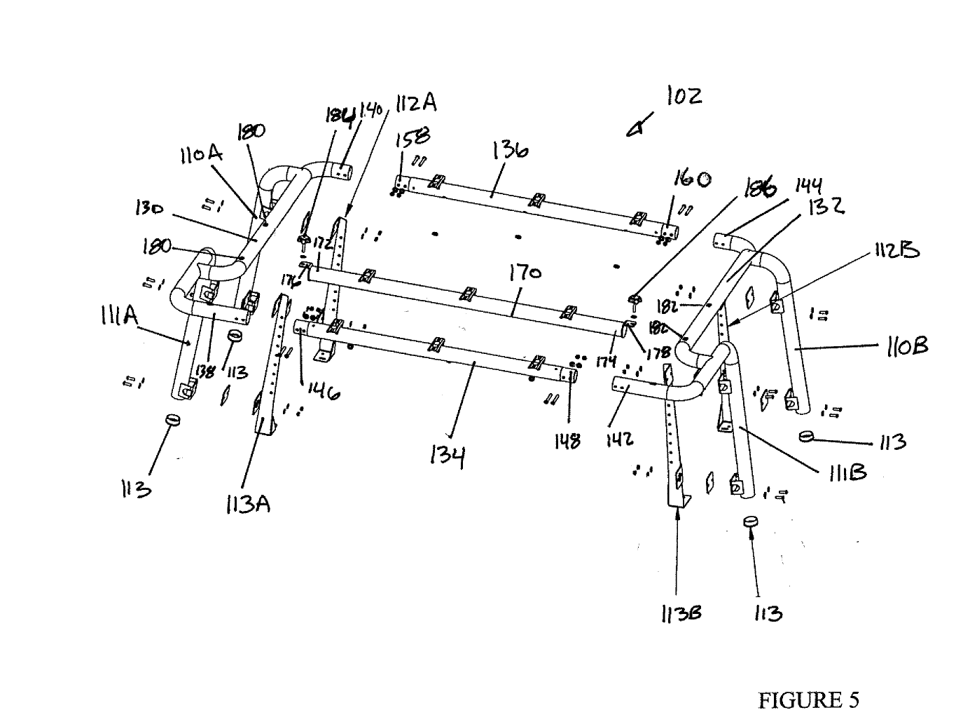

FIG. 4 shows a roof rack 102 connected to a removable canopy 104 of a jeep type vehicle 106 in accordance with another embodiment of the present invention. The roof rack 102 2 has a top rack assembly 108 and a first mounting arm 110A, and a third mounting arm 11A. A similar second mounting arm 110B and fourth mounting arm 111B are shown in FIG. 5. The first mounting arm 110A, the second mounting arm 110B, the third mounting arm 111A, and the fourth mounting arm 111B extend downward from the top rack assembly 108. As shown, a respective end cap 113 is fitted into a bottom end of each of the first mounting arm 110A, the second mounting arm 110B, the third mounting arm 111A, and the fourth mounting arm 111B, and secured by friction fit.

The connection of the first mounting arm 110A to a first support bracket 1128 and the second mounting arm 110B to the second support bracket 1128 is made at two locations shown in FIG. 5. Similarly, the connection of the third mounting arm 111A to a third support bracket 113A, and the fourth mounting arm 111B to a fourth support bracket 113B is made at two locations shown in FIG. 5. The connections are similar to connections shown in the embodiment of FIG. 3.

FIG. 5 also shows the rack member comprising a first side member 130, a second side member 132, a front member 134, and a rear member 136. The first side member 130 has a front end 138 and a rear end 140. Similarly, the second side member has a front end 142 and a rear end 144.

The front member 134 has a first end 146 and a second end 148. The first end 146 and second end 148 have a reduced diameter such that they can be fitted into respective front ends 138 and 142 of the first side member 130 and second side member 132, respectively. The front member 134 is connected to lead the first side member 130 by inserting the first end 146 of the front member into the front end 138 and then securing the connection using bolts inserted through apertures in each of the first end and front end and then securing the bolts with nuts. A similar connection is made to fix the second end 148 of the front member 134 to the front end 142 and the second side member 132. The second end 148 is inserted into the front end 142 and secured thereto using bolts inserted through respective holes in the second end 148 and front end 142 and are then secured using nuts.

The rear member 136 as a reduced diameter first end 158 and a reduced diameter second end 160. The rear member 136 is connected to the respective first side member 130 and second side member 132 and as follows. The reduced diameter first end 158 is inserted into the rear end of the first side member 140 and secured thereto using bolts inserted through respective holes in the first end 158 and rear end 140 and are secured by nuts. The second end 160 is inserted into the rear end 144 of the second side member 132 and secured thereto using bolts inserted through respective holes in the second end 160 and rear end 144 and secured using nuts.

Also shown in FIG. 5 is a removable horizontal member 170 which can be positioned in various horizontal locations of the rack member. The removable member is adjustably secured to the respective first side member 130 and second side member 132 as follows. The removable member 170 has a first end 172 and a second end 174. The first end 172 has a first bracket 176 with an aperture, and the second end 174 has a second bracket 178 with an aperture. The first side member 130 has threaded apertures. A plurality of threaded apertures 180 and the second side member 132 has a plurality of threaded apertures 182. The first bracket 176 is attached to the first side member 130 by positioning the aperture in the first bracket over top of one of a user selected threaded hole 180 and then threadably securing a threaded knob 184 into the user selected threaded aperture 180. Similarly, the second bracket 178 is secured to the second side member by positioning the aperture in the second end 174 over top of a user selected threaded aperture 182 and threadably securing a threaded knob 186 thereto.

The removable member 170 can be positioned at user selected horizontal locations on each of the first side member and second side member by selecting a desired threaded aperture on respective first side member 30 and second side member 132.

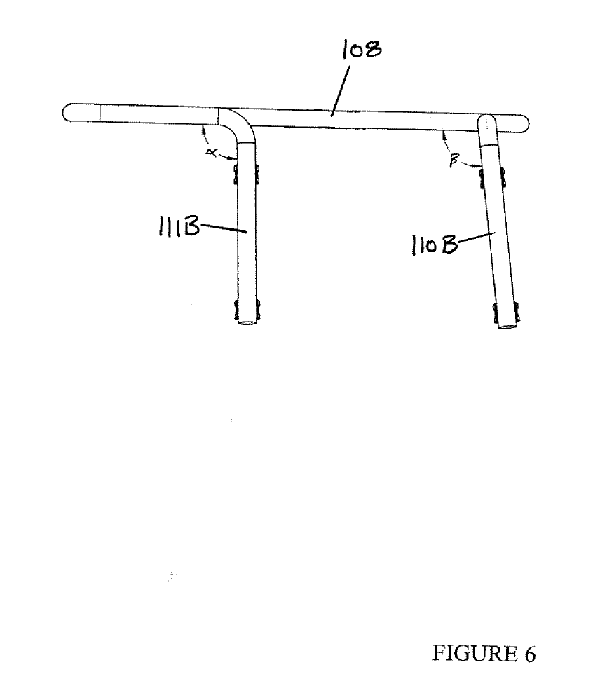

FIG. 6 shows the roof rack of FIG. 4 in side view. Preferably, angle α is 92 degrees. Preferably, angle β is 97 degrees.

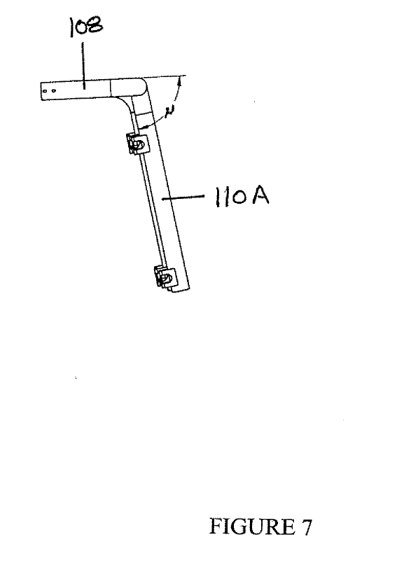

FIG. 7 shows the between the first support arm of the roof rack in FIG. 4. Preferably angle μ is 81 degrees.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A roof rack for attachment to a vehicle having a removable canopy, the removable canopy having a top panel with a first edge and a second edge, a first side panel having an inner side and an outer side, the first side panel extending downward from the first edge, and a second side panel having an inner side and an outer side, the second side panel extending downward from the second edge;
the roof rack comprising a rack member with a first mounting arm and a second mounting arm, a first support bracket, and a second support bracket,
the first mounting arm disposed at the outer surface of the first side panel and attached to the first support bracket positioned at the inner surface of the first side panel with a portion of the first side panel disposed therebetween;
the second mounting arm disposed at the outer surface of the second side panel and attached to the second support bracket positioned at the inner surface of the second side panel with a portion of the second side panel disposed therebetween;
such that the rack member is supported above the top panel.

2. The roof rack of claim 1, wherein the roof rack further comprises a third mounting arm, a fourth mounting arm, a third support bracket and a fourth support bracket, wherein
the third mounting arm is connected to the rack member and disposed at the outer side of the first side panel attached to the third support bracket positioned at the inner surface of the first side panel with a portion of the first side panel disposed therebetween;
the fourth mounting member is connected to the rack member and disposed at the outer surface of the second side panel and attached to the fourth support bracket positioned at the inner side of the second side panel, with a portion of the second side panel disposed therebetween.

3. The roof rack of claim 1, wherein the canopy is made of fiberglass.

4. The roof rack of claim 1, wherein the first mounting arm is connected to the first support bracket by mechanical fasteners, and the second mounting arm is connected to the second support bracket by mechanical fasteners.

5. The roof rack of claim 4, wherein a first sealing member is provided between the first mounting arm and the canopy proximate the attachment of the first mounting arm and the first support bracket, and a second sealing member is provided between the second mounting arm and the canopy proximate the attachment of the second mounting arm and the second support bracket.

6. The roof rack of claim 1, wherein the first support bracket and the second support bracket are connected to the vehicle by mechanical fasteners.

7. The roof rack of claim 1, wherein the rack member has a first side member, a second side member, a front member, and a rear member, wherein
the first side member has a front end and a rear end, and the second side member has a front end and a rear end, the front member is connected between the front end of the first side member and the second side member, and the rear member is connected between the rear end of the first side member and the rear end of the second side member, and
the first mounting arm is connected to and extends downwardly from the first side member, and the second mounting arm is connected to and extends downwardly from the second side member.

8. The roof rack of claim 7, wherein the rack member has at least one movable cross member having a first end and a second end, the first end is removably connected to the first side member, and the second end is removably connected to the second side member such that the at least one movable cross member can be connected at various user selected positions on the first and second side members.

9. The roof rack of claim 8, wherein the first and second ends of the at least one movable member has an aperature therethrough, and the at least one movable cross member is attached to the first and second side members by rotatably inserting a threaded knob into a respective threaded hole in the first and second side members.

10. A roof rack for attachment to a vehicle having a removable canopy, the removable canopy having a top panel extending in a generally horizontal plane, the top panel having a first horizontal edge and a second horizontal edge, a first side panel extending downward from the first horizontal edge, the first side panel having an inner surface and an outer surface, and a second side panel extending downward from the second horizontal edge, the second side panel extending downward from the second edge,
wherein the roof rack comprises a rack member having a first support member, a second support member, a third support member, a fourth support member, and a first mounting bracket, second mounting bracket, a third mounting bracket and a fourth mounting bracket,
the first support member disposed at the outer surface of the first side panel and having a first attachment bracket connecting to the first mounting bracket disposed at the inside of the removable canopy with a portion of the first side panel disposed therebetween;
the second support member disposed at the outer surface of the second side panel and having a second attachment bracket connecting to the second mounting bracket positioned at the inner surface of the second side panel with a portion of the second side panel disposed therebetween;
the third support member disposed at the outer surface of the first side panel and having a third attachment bracket connecting to the third mounting bracket disposed at the inside of the removable canopy with a portion of the first side panel disposed therebetween; and
the fourth support member disposed at the outer surface of the second side panel and having a fourth attachment bracket connecting to the second mounting bracket positioned at the inner surface of the second side panel with a portion of the second side panel disposed therebetween;
wherein the rack member is supported at a horizontal distance above the top panel.

11. The roof rack of claim 10, wherein:
the first support member has a fifth attachment bracket connecting the first support member to the first mounting bracket;
the second support member has a sixth attachment bracket connecting the second support member to the second mounting bracket;
the third support member has a seventh attachment bracket connecting the third support member to the third mounting bracket; and
the fourth support member has a eighth attachment bracket connecting the fourth support member to the fourth mounting bracket.

12. The roof rack of claim 10, wherein the canopy is made of fiberglass.

13. The roof rack of claim 10, wherein a first sealing member is provided between the connection of the first mounting member and the canopy, a second sealing member is provided between the connection of the second mounting member and the canopy;
a third seal is provided between the connection of the third mounting member and the canopy, and a fourth sealing member is provided between the connection of the fourth mounting member and the canopy.

14. The roof rack of claim 13, wherein the first mounting member is connected to the first support bracket by mechanical fasteners, the second mounting member is connected to the second support bracket by mechanical fasteners, the third mounting member is connected to the third support bracket by mechanical fasteners, and the fourth mounting member is connected to the fourth support bracket by mechanical fasteners.

15. The roof rack of claim 14, wherein the first support bracket, the second support bracket, the third support bracket and the fourth support bracket are connected to the vehicle by mechanical fasteners.

16. The roof rack of claim 10, wherein the rack member has a first side member, a second side member, a front member, and a rear member;
the first side member is connected to the first mounting member and the third mounting member;
the second side member is connected to the second mounting member and the fourth mounting member;
the front member having a first end connected to the first side member and a second end connected to the second side member, and
the rear member having a first end connected to the first side member and a second end connected to the second side member.

17. The roof rack of claim 16, wherein at least one movable cross member has a first end and a second end, the first end is removably connected to the first side member, and the second end is removably connected to the second side member.

18. The roof rack of claim 17, wherein the at least one movable cross member is attached by screwing a threaded knob into a respective threaded hole in the first and second side members.
